(19) United States
(12) Patent Application Publication
(10) Pub. No.: US 2003/0122943 A1
(43) Pub. Date: Jul. 3, 2003

(54) Method of storing data, a method of storing and reproducing data and an image-pickup apparatus

(75) Inventor: Tamotsu Irie, Tokyo (JP)

Correspondence Address: HOGAN & HARTSON L.L.P., 500 S. GRAND AVENUE, SUITE 1900, LOS ANGELES, CA, 90071-2611, US

(73) Assignee: CASIO COMPUTER CO., LTD.

(21) Appl. No.: 10/329,955

(22) Filed: Dec. 26, 2002

(30) Foreign Application Priority Data
Dec. 28, 2001 (JP) 2001-399387
Dec. 4, 2002 (JP) 2002-351867

(51) Int. Cl. H04N 5/76; H04N 5/222; H04N 5/91

(52) U.S. Cl. 348/231.4; 348/231.2; 348/231.7; 386/96; 386/117; 348/333.02

(57) ABSTRACT

A method of storing data includes obtaining image data, preparing sound data to be added to the obtained image data, generating image-data identifying data for identifying the obtained image data and sound-data identifying data for identifying the prepared sound data, and associating the generated image-data identifying data with the generated sound-data identifying data and storing the image-data identifying and sound-data identifying data associated with each other.

### BACKGROUND OF THE INVENTION

1. Field of the Invention

The present invention relates to a method of storing image data and sound data, and a method of storing and reproducing data, and relates to an image-pickup apparatus for recording image data and sound data.

2. Conventional Technologies

There are several conventional technologies for recording and reproducing image data and related sound data. In one conventional technology, image data obtained through a digital camera is read into a personal computer and voice data is separately acquired. The image data and voice data are subjected to an editing process to be recorded later on the same recording medium.

In another conventional technology, image data is obtained through a video camera and sound data input from a microphone are recorded on a recording medium at the same time.

In the reproducing mode of these conventional technologies, the image data is read out from the recording medium for display, and the sound data is simultaneously read out for sounding.

### SUMMARY OF THE INVENTION

In the above conventional technology, since the image data and an arbitrary sound data are recorded on the same recording medium, a desired voice can be added to a particular reproduced image. But complex editing operations are required to be executed on the personal computer, and therefore only such persons having knowledge or editing skills are allowed to enjoy the above, only after time consuming and difficult editing operations.

Meanwhile, in the other conventional technology, the image data and the sound data are sequentially recorded in an image-pickup mode, and therefore, without using a particular editing process in the recording mode, the image data and the sound data are associated with each other and recorded in a simple manner. But since the sound data is input and recorded through the microphone, the image cannot be reproduced with desired sound added.

In so called post-recording technology, after an image is taken in, sound data may be added to the image data. In any case, post-processing is required to add the sound data to the image data.

The present invention has been made to overcome the problems involved in the conventional technologies. It is an aspect of the present invention to provide a method of recording data, a method of recording/reproducing data and an image-pickup apparatus, in which the image data and the sound data of desired music and sound are associated with each other for storage, and an image is reproduced with desired sound added.

A method of storing data includes obtaining image data, preparing sound data to be added to the obtained image data, and generating image-data identifying data for identifying the obtained image data and sound-data identifying data for identifying the prepared sound data. The method further includes associating the generated image-data identifying data with the generated sound-data identifying data and storing the image-data identifying and sound-data identifying data associated with each other.

According to the above method, since the image-data identifying data for identifying the image data and the sound-data identifying data for identifying the sound data to be added to the image data are stored in association with each other, the image data is indirectly associated with the sound data. Therefore, without the editing operation to edit the image data and the sound data, the image data and desired sound data may be stored in association with each other in a simple manner.

A method of storing data according to the invention includes obtaining image data, preparing sound data to be added to the obtained image data, generating sound-data identifying data for identifying the prepared sound data, and associating the obtained image data with the generated sound-data identifying data and storing the image data and sound-data identifying data associated with each other.

In the method above, by storing in association with each other the image data and the sound identifying data for identifying the sound data to be added to the image data, the image data and the sound data are indirectly associated with each other. Therefore, without editing operation to edit the image data and the sound data, the image data and desired sound data may be stored in association with each other in a simple manner.

A method of storing data according to the invention includes obtaining image data, preparing sound data to be added to the obtained image data, generating image-data identifying data for identifying the obtained image data, and associating the generated image-data identifying data with the prepared sound data and storing the image-data identifying data and prepared sound data associated with each other.

According to the above method since the image-data identifying data and the sound data to be added to the image data are stored in association with each other, the image data and the sound data are indirectly associated to each other. Therefore, without any operation to edit the image data and the sound data, the image data and desired sound data are stored in association with each other.

In a method of storing data according to an embodiment of present invention, the sound data referred therein is tune data, which is used for automatic musical performance. Therefore, the image data can be associated with a desired tune data in a simple manner without any operation to edit the image data and the tune data, when these data are stored.

In a method of storing data according to the invention the sound data referred therein is voice data for reproducing voice. Therefore, the image data and desired voice data are associated to each other without any operation to edit the image data and the voice data, when these data are stored.

A method of storing data according to the invention in an apparatus to be operated by a user, having a first storage for storing tune codes respectively corresponding to MIDI data of plural tunes and a second storage, includes, selecting in response to a first operation by the user, a tune code from among the tune codes stored in the first storage, obtaining image data in response to a second operation by the user, creating a filename for storing the obtained image data, by using the selected tune code in response to the second operation of the user, and storing in the second storage the obtained image data with the created filename.

As stated above, since the filename is created for the image file for storing the image data by using the selected tune code, an image is associated with the MIDI data of a tune through the filename of the image file.

A method of storing and reproducing data according to the invention includes obtaining image data, preparing sound data to be added to the obtained image data, generating image-data identifying data for identifying the obtained image data and sound-data identifying data for identifying the prepared sound data to be added to the image data, associating the generated image-data identifying data with the generated sound-data identifying data and storing the image data identifying and sound data identify data associated with each other. The method also includes reproducing an image based on the image data identified by the stored image-data identifying data and outputting sound based on the sound data identified by the stored sound-data identifying data associated with the image-data identifying data.

As described above, without any operation to edit the image data and the sound data, image data and a desired sound data are stored in association with each other, and an image is displayed based on the image data and sound is output based on the desired sound data in association with the display of the image.

A method of storing and reproducing data according to the invention includes obtaining image data generating sound data to be added to the obtained image data creating sound-data identifying data for identifying the generated sound data associating the obtained image data with the sound-data identifying data and storing the image data identifying and sound-data identifying data associated with each other, and reproducing an image based on the stored image data and outputting sound based on the sound data identified by the stored sound-data identifying data associated with the stored image data.

As described above, without any operation to edit the image data and the sound data, image data and a desired sound data are stored in association with each other, and an image is displayed based on the image data and sound is output based on the desired sound data in association with the display of the images.

A method of storing and reproducing data according to the invention includes obtaining image data, preparing sound data to be added to the obtained image data, generating image-data identifying data for identifying the obtained image data, associating the generated image-data identifying data with the prepared sound data and storing the image data identifying and sound data identifying data associated with each other, and reproducing an image based on the image data identified by the stored image-data identifying data and outputting sound based on the stored sound data stored and associated with the stored image-data identifying data.

As described above, without any operation to edit the image data and the sound data, image data and a desired sound data are stored in association with each other, and an image is displayed based on the image data and sound is output based on the desired sound data in association with the display of the image.

In a method of storing and reproducing data according to the invention an image filename stored in a non-volatile memory includes, as a part of the filename, a series of letters corresponding to music data. Therefore, when the image files are browsed, a sound source section can reproduce a music signal of the music data corresponding to the image filename.

In a method of storing and reproducing data according to the invention the non-volatile memory is provided with scene folders corresponding to previously selected scenes and a tune selection list in which titles of previously selected tune data are described, and when the image files are browsed, the sound source section can reproduce a tune signal based on the corresponding tune data.

A method of storing and reproducing data in an apparatus to be operated by a user, having a first storage for storing MIDI data of plural tunes and tune codes representing the MIDI data, and a second storage includes selecting in response to first operation of the user a tune code from among the tune codes stored in the first storage, obtaining image data in response to second operation of the user, creating in response to the second operation of the user an image-file name for storing the obtained image data, by using the selected tune code, storing in the second storage the obtained image data with the created image-file name, selecting in response to a third operation by the user an image-file names from among the image-file names stored in the second storage, reading out from the second storage the image data represented by the selected image-file name, and reproducing an image based on the read out image data, detecting the tune code used in the image-file name selected in response to the third operation, and reading out from the first storage the MIDI data represented by the detected tune code and reproducing a tune based on the read out MIDI data.

As described above, since the name of image file where the image data is contained is created using the selected tune code, the image and the MIDI data are associated with each other through the name of image file, and in the reproducing mode the image and the tune are reproduced which are associated with each other by the name of image file.

An image-pickup apparatus according to the invention includes an image-pickup means for taking a picture of an object to obtain image data of the object, image-data storing means for storing the image data of the object obtained by the image-pickup means, sound-data storing means for storing sound data to be added to the image data obtained by the image-pickup means, identifying-data generating means for generating image-data identifying data for identifying the image data stored in the image-data storing means and sound-data identifying data for identifying the sound data stored in the sound-data storing means, identifying-data storing means for associating the image-data identifying data generated by the identifying-data generating means with the sound-data identifying data generated by the identifying-data generating means, and for storing the image-data identifying data and sound-data identifying data associated to each other, and reproducing means for reproducing an image based on the image data identified by the image-data identifying data stored in the identifying-data storing means and for outputting sound based on the sound data identified by the sound-data identifying data stored in the identifying-data storing means.

As described above, since the image-data identifying data for identifying the image data and the sound-data identifying data for identifying the sound data to be added to the image data are connected to each other and stored in the identifying data storing means, the image data and the sound data are indirectly connected to each other. Therefore, without any process to edit the image data and the sound data, the image data and the sound data are connected and stored through a simple process. Further, the reproducing means displays the image based on the image data and outputs related sounds based on the sound data connected to the image data.

An image-pickup apparatus according to the invention includes an image-pickup means for taking a picture of an object to obtain image data of the object, sound-data storing means for storing sound data to be added to the image data obtained by the image-pickup means, identifying-data generating means for generating sound-data identifying data for identifying the sound data stored in the sound-data storing means, identifying-data storing means for associating the image data obtained by the image-pickup means with the sound-data identifying data generated by the identifying-data generating means, and for storing the image data and the sound-data identifying data associated with the image data; and reproducing means for reproducing an image based on the image data stored in the identifying-data storing means and for outputting sound based on the sound data identified by the sound-data identifying data associated with the image data and stored in the identifying-data storing means.

As described above, since the image data and the sound-data identifying data for identifying the sound data to be added to the image data are connected to each other and stored in the identifying-data storing means, the image data and the sound data are indirectly connected to each other. Therefore, without any process to edit the image data and the sound data, the image data and the desired sound data are connected and stored through a simple process. Further, the image can be displayed based on the image data and related sound can be output based on the sound data connected to the image data by the reproducing means.

An image-pickup apparatus according to the invention includes image-pickup means for taking a picture of an object to obtain image data of the object, image-data storing means for storing the image data of the object obtained by the image-pickup means, sound-data storing means for storing sound data to be added to the image data obtained by the image-pickup means, identifying-data generating means for generating image-data identifying data for identifying the image data stored in the image-data storing means, identifying-data storing means for associating the image-data identifying data generated by the identifying-data generating means with the sound data stored in the sound-data storing means, and for storing the image-data identifying data and the sound data associated with the image-data identifying data, and reproducing means for reproducing an image based on the image data identified by the image-data identifying data stored in the identifying-data storing means and for outputting sound based on the sound data stored in the identifying-data storing means.

As described above, since the image-data identifying data for identifying the image data and the sound data to be added to the image-data identifying data are connected to each other and stored in the identifying-data storing means, the image data and the sound data are indirectly connected to each other. Therefore, without any process to edit the image data and the sound data, the image data and the desired sound data are connected to each other and stored through a simple process. Further, the image can be displayed based on the image data and related sound can be output based on the sound data connected to the image data by the reproducing means.

An image pickup apparatus according to the invention includes a first storing means for storing MIDI data of plural tunes and tune codes representing the MIDI data respectively, first selecting means for selecting in response to first selecting operation by the user a tune code from among the tune codes stored in the first storing means, a shutter key, image-pickup means for taking a picture of an object in response to operation by the user of the shutter key to obtain image data of an object, filename preparing means for creating in response to the operation by the user of the shutter key an image-file name for storing the image data of the object obtained by the image-pickup means by using the tune code selected by the first selecting means, second storing means for storing the image data with the image-file name prepared by the filename preparing means; second selecting means for selecting in response to second selecting operation by the user an image-file name from among the image-file names stored in the second storing means, image-reproducing means for reading out from the second storing means the image data represented by the image-file name selected by the second selecting means, and for reproducing an image based on the read out image data, detecting means for detecting a tune code used in the image filename selected by the second selecting means, and tune-reproducing means for reading out from the first storing means the MIDI data of the tune represented by the tune code detected by the detecting means, and reproducing the tune based on the read out MIDI data.

As described above, since the image-file name for storing the image data is created by using the selected tune data, an image and the MIDI data are connected through the image-file name. Therefore, in the reproducing mode the image and the tune, which are connected to each other through the image-file name, are reproduced simultaneously.

An image pickup apparatus according to the invention includes a camera section, a sound source section, and a control section. The camera section includes an imaging device for obtaining image data of an object. The sound source section includes a first storage for storing at least one musical-sound data, a converter for generating a digital musical signal from the musical-sound data stored in the first storage and for converting the digital musical signal into an analog signal, whereby it outputs an audio signal corresponding to the musical-sound data. The control section includes a second storage for storing the image data obtained by the camera section, an non-volatile memory cooperative with the second storage for reading and writing the image data obtained by the camera section, for storing the image data in a file format, a display device for displaying an image based on the image data stored in the second storage and an operation switch. The image data stored in the file format on the non-volatile memory has an image-file name which includes a tune code corresponding to the musical-sound data which is selected from musical-sound data previously stored in the first storage by the operation of the operation switch, and when the image file is browsed, the sound source section outputs a musical sound signal based on the musical-sound data corresponding to the image-file name of the browsed image file.

As described above, since the tune code for the tune previously selected is included in the image-file name for storing the image data, the image and the music data are connected to each other through the image-file name, and when the image file is browsed, the audio signal is output based on the music data for the tune code corresponding to the image-file name.

The image pickup apparatus according to the invention described above has the sound source section including at least one electronic music data stored in the first storage and a performance circuit for converting the electronic music data into a digital audio signal.

A method of storing image data according to the invention includes selecting a piece of sound information from a first storage together with sound-information identifying information, obtaining image data, creating a filename for storing the obtained image data, and storing the obtained image data in a second storage with the created filename. The first storage stores plural pieces of sound information. A piece of sound information is selected from the plural pieces of sound information stored in the first storage in response to a selecting operation of a user. The image data is operated in response to an obtaining information by the user. The filename for storing the obtained image data is created by using the sound-information identifying information for identifying the selected sound information.

According to the above method, since the image data is created by using the sound-information identifying information for identifying the selected sound information, the image data is indirectly associated with the sound information. Therefore, the image data and desired sound information may be stored in association with each other in a simple manner.

A method of storing image data according to the invention includes selecting a piece of sound information from a first storage together with sound-information identifying information, obtaining image data, selecting a folder from plural folders, and storing in the selected folder sound-information identifying information and the obtained image data. The first storage stores plural pieces of sound information, and a piece of sound information is selected from the plural pieces of sound information in the first storage in response to a selecting operation of a user. The image data is operated in response to an obtaining information by the user. The sound-information identifying information, which identifies the selected sound information, is stored in the file selected from plural folders together with the obtained image data.

According to the above method, the image data and sound-information identifying information are stored in the same selected folder, the image data is indirectly associated with the sound information. Therefore, the image data and desired sound information may be stored in association with each other in a simple manner.

In a method of storing data according to an embodiment of present invention, the sound information referred therein is tune data, and the sound-information identifying information may be made of a tune code representing tune data. Therefore, the image data and desired tune data may be stored in association with each other in a simple manner.

In a method of storing data according to an embodiment of present invention, the tune data referred therein is MIDI data of the tune. Therefore, the image data and desired MIDI data of the tune data may be stored in association with each other in a simple manner.

In a method of storing data according to an embodiment of present invention, the obtained image data of the method of storing image data could be obtained by taking a picture of an object. Therefore, the image data obtained by taking a picture of an object and desired sound information may be stored in association with each other in a simple manner.

A method of storing image data according to the present invention includes displaying plural scenes for selection, selecting a scene from the plural displayed scenes, selecting a scene folder corresponding to the selected scene, displaying a list of sound information belonging to the selected scene, selecting a piece of sound information from the displayed list of sound information, storing in the selected scene folder sound-information identifying information for identifying the selected sound information, obtaining image data by taking a picture of an object, and storing the obtained image data in the scene folder where the sound-information identifying information has been stored.

According to the above method of storing image data, the image data obtained by taking a picture of an object and the sound-information identifying information are stored in the same scene folder. Therefore, the image data and sound information are indirectly associated with one another in a simple manner when they are stored.

A method of reproducing recorded data according to the invention includes selecting a reproducing mode, then in response to the selection of the reproducing mode, displaying a scene folder where image data for each scene and sound-information identifying information for identifying sound information are previously stored, selecting the sound-information identifying information stored in the scene folder, reading out from a storage the sound information identified by the selected sound-information identifying information to perform a sounding process, and displaying an image based on the image data which is stored in the scene folder together with the sound-information identifying information.

According to the above method of reproducing recorded data, since the image data is stored together with the sound-information identifying information in the same scene folder, the image data and desired sound information are indirectly associated with each other. Therefore, without any operation to edit the image data or the sound data, the desired sound information is read out, while the image associated with the desired sound information is displayed.

A method of storing and reproducing image data of the invention includes selecting, in response to a selecting operation of a user, a piece of sound information together with sound-information identifying information from a first storage, obtaining image data in response to the user's obtaining operation, using the sound-information identifying information, creating a filename for storing the obtained image data, and storing the obtained image data with the created filename in a second storage. The sound-information identifying information identifies the selected sound information. The first storage stores plural pieces of sound information. The method further includes selecting an image filename from the image filenames stored in the second storage, reading out from the second storage image data represented by the selected image filename and reproducing an image based on the read out image data, detecting the sound-information identifying information used in the selected image filename, reading out from the first storage sound information identified by the detected sound-information identifying information, and reproducing sound based on the read out sound information.

According to the above method of storing and reproducing recorded data, since the image data is stored together with the sound-information identifying information in the same storage, the image data and desired sound information are indirectly associated with each other. Therefore, without any operation to edit the image data or the sound data, the desired image is reproduced based on the image data read out from the folder, while the sound is reproduced based on the sound information read out from the storage.

In a method of storing and reproducing image data according to an embodiment of present invention, the sound information referred therein includes tune data, and the sound-information identifying information includes a tune code representing tune data. Therefore, without any operation to edit the image data or the sound data, the desired image is reproduced based on the image data read out from the folder, while the tune data is reproduced based on the sound information read out from the storage.

In a method of storing and reproducing image data according to an embodiment of present invention, the tune data referred therein includes MIDI data of the tune. Therefore, without any operation to edit the image data or the MIDI data of the tune data, the desired image is reproduced based on the image data read out from the folder, while the desired MIDI data of tune data is reproduced based on the sound information read out from the storage.

In a method of storing and reproducing image data according to an embodiment of present invention, the obtained image data of the method of storing image data could be obtained by taking a picture of an object. Therefore, without any operation to edit the image data or the sound information, the desired image obtained by taking a picture of an object is reproduced based on the image data read out from the folder, while the desired sound is reproduced based on the sound information read out from the storage.

An image-pickup apparatus according to the invention includes a sound source section and a camera section. The sound source section includes a sound-information storage for storing plural pieces of sound information and plural pieces of sound-information identifying information for identifying the plural pieces of sound information respectively. The camera section includes an image pickup for taking a picture of an object to obtain an image data of the object, image-filename creator for creating an image filename using previously selected sound source information, storage for storing the image data of the object obtained by the image pickup in the image filename created by the image-filename creator, and image reproducer for reading out from the storage in a reproducing mode the image data represented by a previously selected image filename to reproduce an image based on the read out image data. The sound source section further comprises sound reproducer for reproducing sound based on the sound information identified by the sound-information identifying information used in the previously selected image filename.

In the above image-pick up apparatus according to the invention, since the image data and the sound-data identifying data for identifying the sound data are associated with each other and stored in the storage, the image data and the sound data are indirectly associate with each other. Therefore, without any editing of the image data or the sound data, the image data and the desired sound data are stored through a simple process. Further, the image can be reproduced based on the image data by the image reproducer and related sound can be reproduced based on the sound data connected to the image data by the sound reproducer.

An image-pickup apparatus according to the invention includes a sound source section and a camera section. The sound source section includes sound-information storing means for storing plural pieces of sound information and plural pieces of sound-information identifying information for identifying the plural pieces of sound information respectively. The camera section includes an image pickup for taking a picture of an object to obtain in image data of the object, storage for associating the image data of the object obtained by the image pickup means with a previously selected sound-information identifying information, and for storing the image data and the sound-information identifying information associated with each other, and image reproducer for reading out from the storing means in a reproducing mode previously selected image data, and for reproducing an image based on the read out image data. The sound source section further includes sound reproducer for reproducing sound based on the sound information identified by the sound-information identifying information associated with the previously selected image data.

In the above image-pick up apparatus according to the invention, since the image data and the sound-data identifying data for identifying the sound data are associated with each other and stored in the storage, the image data and the sound data are indirectly associate with each other. Therefore, without any editing of the image data or the sound data, the image data and the desired sound data are stored through a simple process. Further, the image can be reproduced based on the image data by the image reproducer and related sound can be reproduced based on the sound data connected to the image data by the sound reproducer.

In the image-pickup apparatus according to an embodiment of the invention, the storage referred therein stores the image data obtained by the image pickup means in a scene folder previously selected form plural scene folders which correspond to scenes respectively with by associate, whereby associating the image data with the scene folder.

In the image-pickup apparatus according to an embodiment of the invention, the sound information referred therein includes tune data, and the sound-information identifying information includes a tune code representing tune data. The tune data referred in the above image pick-up apparatus may further include MIDI data of tune.

An image pickup apparatus according to the invention includes a camera section having an image pickup element, first storage, sound source section, second storage, non-volatile memory, display device, and control section. The image pickup element obtains image data. The first storage stores at least one music data. A sound source section includes a converter for converting a digital music signal to an analog signal, the digital music signal being composed of the music data. The sound source then outputs an audio signal based on a selected music data. The second storage stores the image data obtained by the camera section. The non-volatile memory, cooperative with the second storage for reading and writing the image data obtained by the camera section, stores the image data in a file format. The display device displays an image based on the image data stored in the second storage. The control section has an operation switch. The filename stored in the non-volatile memory contains as a part of the name the tune code corresponding to the music data previously selected from music data stored in the first storage by the operation switch, and the sound source section outputs an audio signal based on the music data of the tune code corresponding to the image filename, when the image files are referred.

As described above, since the tune code for the tune previously selected is a part of the name of the image filename for storing the image data, the image and the music data are connected to each other through the image filename, and when the image file is browsed, the audio signal is output based on the music data for the tune code corresponding to the image filename.

An image pickup apparatus according to the invention includes a first storage, first selector, image pickup, filename creator, second storage, second selector, image reproducer, detector, and tune reproducer. The first storage stores MIDI data for plural tunes and tune codes each representing MIDI data for a tune. The first selector selects in response to a selecting operation by a user a tune code from the plural tune codes stored in the first storage. The image pickup takes a picture of an object in response to a shutter-key operation by a user to obtain image data of the object. The filename creator creates an image filename using the tune code which is selected in response to the selecting operation by the first selector. The second storage stores the image data with the image filename created by the filename creator. The second selector selects in response to a selecting operation in a reproducing mode, an image filename from the image filenames stored in the second storage. The image reproducer reads out from the second storage the image data represented by the image filename selected by the second selector, and reproduces an image based on the read out image data. The detector detects a tune code used in the image filename selected by the second selector. The tune reproducer reads out from the first storage MIDI data represented by the tune code detected by the detector, and reproduces a tune based on the read out MIDI data.

As described above, since the image filename for storing the image data is created by using the selected tune data, an image and the MIDI data are associated with each other through the image filename. Therefore, in the reproducing mode, the image and the tune, which are connected to each other through the image filename, are reproduced together.

The image pickup apparatus according to one embodiment of the invention, the sound source section has at least an electronic music data stored in the first storage, and includes a performance circuit for converting the electronic music data to a digital audio signal.

### BRIEF DESCRIPTION OF THE DRAWINGS

FIG. 1 is a block diagram of circuitry of the digital camera according to the first embodiment of the invention;

FIG. 2 is a representation of a conception showing a tune-data list stored in the first ROM;

FIG. 3 is a representation of a conception showing a sound-data list stored in the second ROM;

FIG. 4 is a flowchart showing processes executed by the control section of the first embodiment in the image-pickup mode;

FIG. 5 is a flowchart showing processes executed by the sound source section;

FIG. 6 is a flowchart showing processes executed by the camera section;

FIG. 7 is a flowchart showing processes executed by the control section of the first embodiment in the reproducing mode;

FIG. 8 is a flowchart showing processes executed by the control section of the second embodiment in the image-pickup mode;

FIG. 9 is a drawing showing an example of the selection chart;

FIG. 10 is a representation of a conception showing how data are stored in the flash memory;

FIG. 11 is a flowchart showing processes executed by the control section of the second embodiment in the reproducing mode;

FIG. 12 is a representation of a conception showing how data are associated with each other in other embodiment of the invention;

FIG. 13 is a representation of a conception showing how data are associated with each other in another embodiment of the invention;

FIG. 14 is a representation of a conception showing how data are associated with each other in still other embodiment of the invention

FIG. 15 is a representation of a conception showing how data are associated with each other in further other embodiment of the invention;

FIG. 16 is a representation of a conception showing how data are associated with each other in still another embodiment of the invention.

### DETAILED DESCRIPTION OF THE PREFERRED EMBODIMENTS

The preferred embodiments of the invention will be described hereafter with reference to the drawings.

(1) First Embodiment.

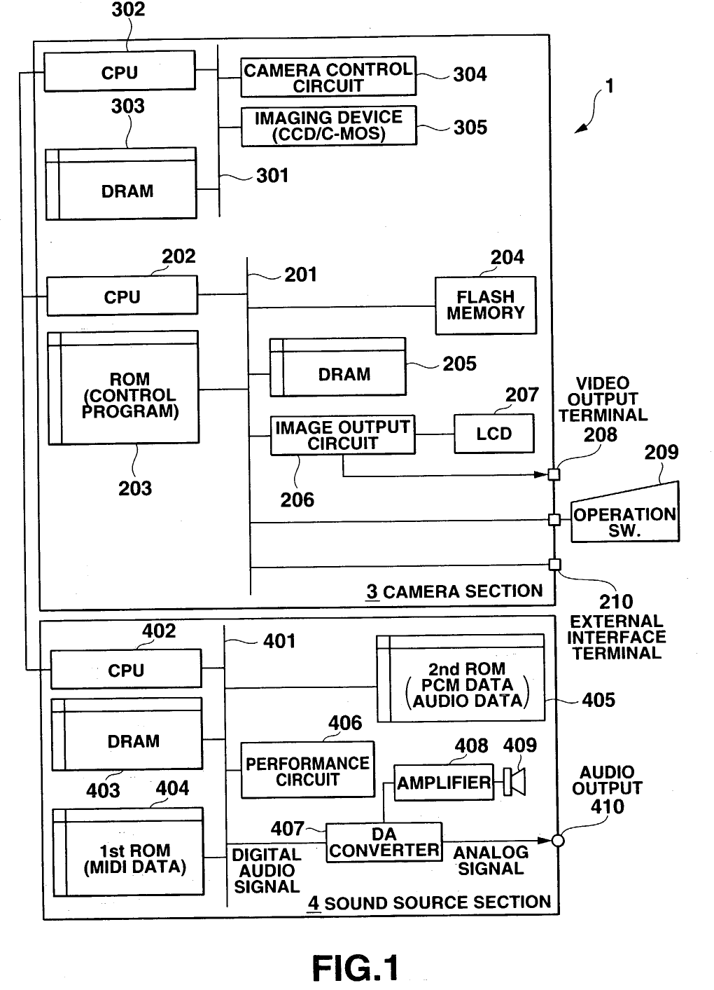

FIG. 1 is a block diagram of circuitry of a digital camera 1 included in the first embodiment of the invention. The digital camera 1 includes a camera section 3 and a sound source section 4. The camera section 3 is provided with CPU 202, ROM 203, a flash memory 204, DRAM 205 and an image output circuit 206, all of which are connected to each other through a bus line 201. The CPU 202 controls each element in the camera section 3 and the sound source section 4. A control program for the CPU 202 to control each section is stored in the ROM 203.

The flash memory 204, which is detachably mounted on the digital camera 1, is a storage for store obtained image data. The DRAM 205 is used to temporarily hold data to be processed. The image output circuit 206 is for converting the image data held in the DRAM 205 to a video signal, and is connected to LCD 207 for displaying an image based on the video signal and to a video output terminal 208 for outputting the video signal. An operation switch 209 and an external interface terminal 210 are connected to the bus line 201. The operation switch 209 is provided with a shutter key as will be described later, a mode setting key for selectively setting an image-pickup mode and/or a reproducing mode, a key for inputting image pickup conditions, and other keys necessary for operating the digital camera 1.

The camera section 3 is provided with CPU 302, DRAM303, a camera control circuit 304 and an imaging device 305, which are connected to each other through a bus line 301. The CPU 302 controls each element in the camera 1, analog/digital converts the image data obtained through the imaging device 305, and temporarily holds the converted digital image data in the DRAM 303 with an image arrangement obtained through a color filter such as CCD without any process. The DRAM 303 is used to temporarily hold image data of an object obtained through the imaging device 305. More specifically, the DRAM 303 has a memory area for holding image data of plural images and is used to temporarily hold plural image data, allowing to speed up image pickuping. The camera control circuit 304 is used to control focusing by optical parts in a lens mechanism and exposure by the imaging device 305. The imaging device 305 includes CCD or C-MOS arranged behind the lens mechanism.

The sound source section 4 is provided with CPU 402, DRAM 403, a first ROM 404, a second ROM 405, a performance circuit 406 and a digital/analog converter (DA converter) 407, all of which are connected though a bus line 401. The CPU 402 is used to control each element in the sound source section 4, and the DRAM 403 is for temporarily holding tune data (MIDI data) or digital audio data. The performance circuit 406 converts the tune data or the digital audio data in the DRAM 403 to a digital audio signal. The DA converter 407 converts the digital audio to an analog signal to reproduce voice. The DA converter 407 is connected to a speaker 409 through an amplifier 408 and also to an audio output terminal 410.

MIDI (Musical Instrument Digital Interface) is classified into a channel message for controlling each element and a system message for controlling the whole MIDI system. The channel message includes general performance information such as note on, note off, program change and pitch bend. The channel message is further classified into a voice message and a mode message. The performance information such as note information is included in the voice message. The mode message functions to decide operation to be performed or decide how to receive the voice message such as monophonic or polyphonic.

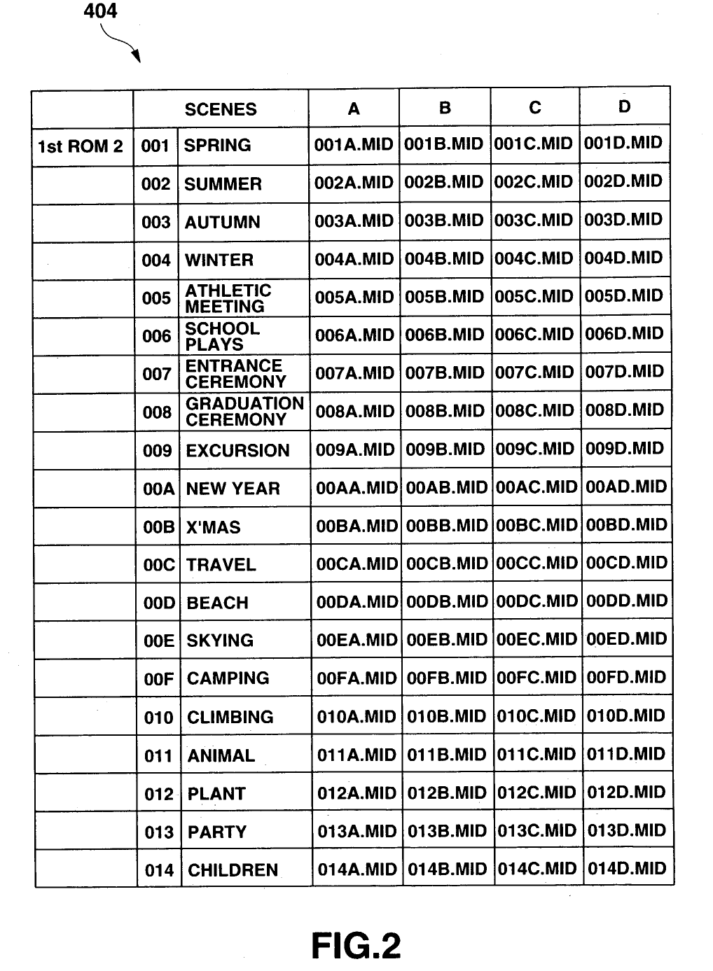

The first ROM 404 stores a tune-data list as shown in FIG. 2. The tune-data list is comprised of scenes corresponding to scene codes “001” through “014” respectively and four symbols “A” through “D” applied to each scene. Each tune code consists of a combination of one of the scene codes “001” through “014” and one of the symbols “A” through “D” with an extension “.MID”, added to the tail of the combination to show that the code is MIDI data, which constitutes a filename of the tune.

In other words, for example, four tune codes “001A”, “001B”, “001C”, and “001D” giving image or feeling of the spring are assigned to the scene code “001” corresponding to “Spring”, and these tune codes with the extension “.MID” added to the end constitute filenames for four tunes, “001A.MID”, “001B.MID”, “001C.MID”, and “001D.MID”. The first ROM 404 stores a total of 80 MIDI data with filenames, “001A.MID” through “014D.MID”, for automatic performance of tunes corresponding to the tune codes.

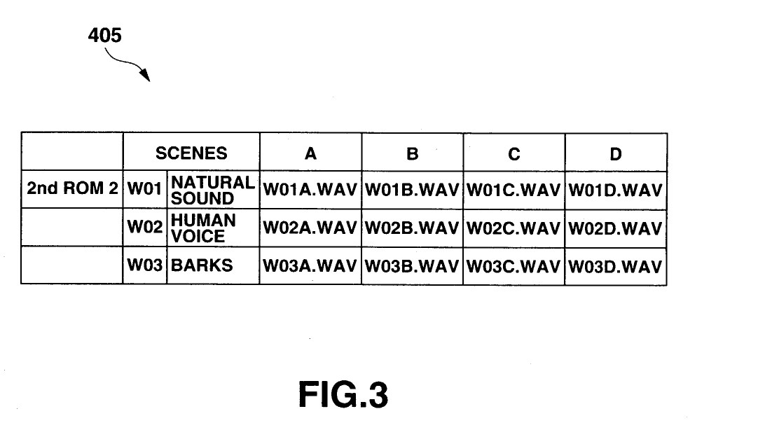

The second ROM 405 stores a sound-data list shown in FIG. 3. The sound-data list includes scenes corresponding to the scene codes “W01” through “W03” and four sound codes of sounds applied to the respective scenes. Each sound code consists of a combination of one of scene codes “W01” through “W03” and one of symbols “A” through “D” with the extension “.WAV”, added to the end to show that the code is sound data, constitutes a filename for the sound.

In other words, for example, four sound codes, “W01A”, “W01B”, “W01C” and “W01D” are assigned to a natural sound corresponding to the scene code “W01”, and these sound codes with the extension “.WAV” added to the tail constitute filenames for natural sounds, “W01A.WAV”, “W01B.WAV”, “W01C.WAV” and “W01D.WAV”. The first ROM 404 stores a total of 12 digital sound data with filenames, “W01A.WAV” to “W03D.WAV”, for outputting sounds based on the sound codes.

(Image-Pickup Mode)

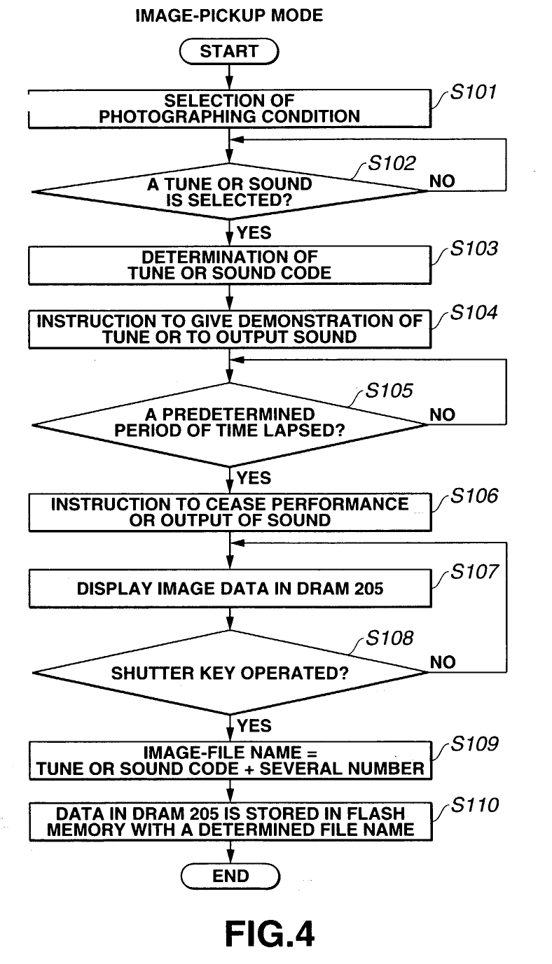

In the above-mentioned embodiment of the invention, when a user operates the operation switch 209 to set the image-pickup mode, the CPU 202 in the camera section 3 follows instructions of the control program stored in the ROM 203 to execute processes in accordance with a flowchart shown in FIG. 4. More specifically, the CPU 202 conveys to the camera section 3 photographing conditions input by operation of the operation switch 209, such as macro photography, distant-scene photography, speed light photography or natural light photography, and arranges the optical mechanism suitably for the selected photographing conditions. (Step S101) The photographing condition defines condition on which a picture is taken to obtain image data.

It is judged which filename is selected, the filename for tune stored in the first ROM 404 or the filename for sound stored in the second ROM 405. (Step S102) When selected, a tune code or a sound code is specified from the filename selected at Step S102. In other words, when the user inputs a desired filename of tune or sound by operating the operation switch 209, the tune code or the sound code is determined from the filename input by the user. For example, when the filename “005A.MID” is selected, the tune code “005A” is determined, and when the filename “W03.WAV” is selected, then the sound code “W03A” is determined.

When the tune code or the sound code is determined at Step S103, the sound source section 4 is instructed to give a demonstration of outputting the tune or the sound based on the code determined at Step S103. (Step S104) When it is judged that a predetermined time has lapsed at Step S105; YES, the sound source section 4 is instructed to cease the demonstration. (Step S106)

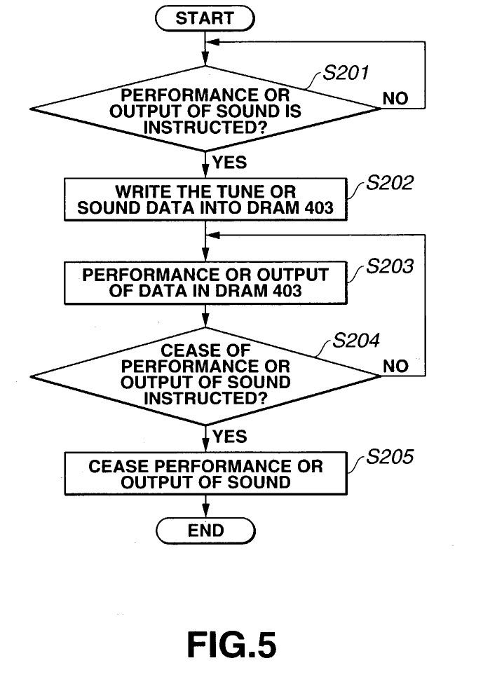

Meanwhile, when the sound source section 4 is instructed to execute a performance of the tune or to output sound (Step S201, YES) as shown in FIG. 5, the tune code of the tune or the sound data is read out from the fist ROM 404 or the second ROM to be written into the DRAM 403 (Step S202), and then the automatic performance is made based on the tune code stored in the DRAM 403 or sound is output based on the sound data stored in the DRAM 403 (Step S203). In the process at Step S203, the tune or the sound is output through the speaker 409. The process at Step S203 continues until the camera section 3 gives instructions to cease the performance or outputting of sound (Step S204; YES). At the time the camera section 3 gives the stop instruction, the automatic performance or the voice output ceases. (Step S205)

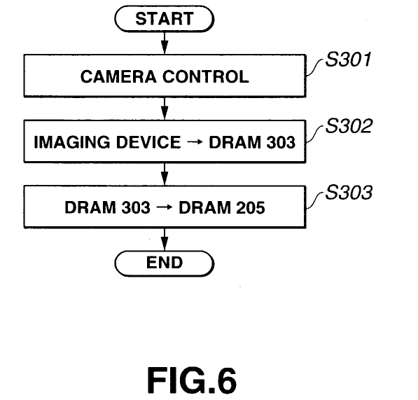

On the other hand, when the camera section 3 receives the photographing conditions selected at Step S101, camera control is exercised to adjust the optical mechanism to meet the photographing conditions, as shown in FIG. 6. (Step S301) The imaging device 305 obtains image data of the object with an exposure condition and a focus adjusted at Step S301. The image data obtained by the imaging device 305 is sent to the DRAM 303 to be temporarily held therein (Step S302) and then further sent from the DRAM 303 to the DRAM 205 in the camera section 3.(Step S303)

The CPU 202 in the camera section 3 applies image processing to the image data stored in the DRAM 303 to convert same into a color difference signal YUV. The color difference signal YUV is stored in the DRAM 205. The color difference signal YUV is converted to display data corresponding to RGB arrangement of the LCD, and then sent to the image output circuit 206 to be displayed on the LCD 207. When the LCD 207 is used as a finder to display a through image, the color difference signal YUV is repeatedly converted to display signal and supplied to the LCD 207. As described above, the image is displayed on the LCD 207 based on the image data stored in the DRAM 205, as shown in FIG. 4. (Step S107) Thus, on the LCD 207 is displayed the through image of the object at which the user aims the digital camera 1. The camera section 3 keeps the LCD 207 displaying the through image until the operation switch 209 is operated by the user to click the shutter key. (Step S108) When the user clicks the shutter key at the time an image to be taken is displayed on the LCD 207, the process advances from Step S108 to Step S109.

At Step S109, the file of the pickup image is named “tune code+serial number” or “sound code+serial number” using the tune code or the sound code determined at Step S103. In other words, if a first image in JPEG format is taken with the tune code “005B” selected, then the file of the first image is named “005B0001.JPG”, and the file of a fifth image is named “005B0005.JPG”. The image data held in the DRAM 205 is stored in the flash memory 204 with the filename determined at Step S103. (Step 110) In other words, the CPU 202 applies the image processing to the image data stored in the DRAM 303 to compress same to obtain data in JPEG format and stores the compressed data in the flash memory 204.

The filename determined at Step S109 is just required to include first eight characters respectively corresponding to image files, and the serial number included in the filename may be intermittent or continuous in the order in which images are taken in. In accordance with requirements for the filename of the digital camera, the filename of image shall be represented by 8 characters of alphabetical and numeral half-size capital-letters and an extension (four characters), and therefore a serial number of several digits may be included in the filename, following the tune code of 3 to 5 characters of alphabetical and numerical half-size capital letters excluding special symbols.

(Reproducing Mode)

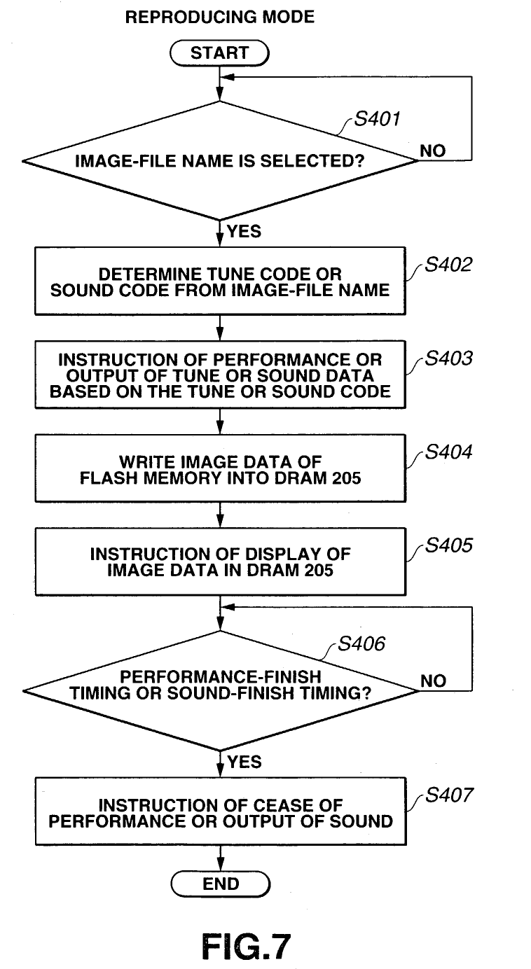

When the user selects the reproducing mode by operating the operation switch 209, the CPU 202 in the camera section 3 starts the process in accordance with a flowchart shown in FIG. 7 under instructions of the control program stored in the ROM 203. The CPU 202 keeps waiting until the user selects either of the image-file names by operating the operation switch 209. (Step S401) When an image-file name is selected, a tune code and a sound code are determined from the selected image-file name. (Step S402) Since the image-file name consists of a tune code and a serial number or a sound code and a serial number as described before, the tune code or the audio code is easily determined from the selected image-file name.

The CPU 202 instructs the sound source section 4 to execute performance based on tune data corresponding to the selected tune code or to output sound based on sound data corresponding to the selected sound code. (Step S403) As described in the flowchart of FIG. 5, the sound source section 4 executes the automatic performance based on the tune data held on the DRAM 403 or outputs sound based on the sound data held on the DRAM 403. (Step S203) In the process at Step S203, music or sound is output through the speaker 409.

Further, the camera section 3 reads out from the flash memory 204 the image data of the selected image-file name and writes on the DRAM 205 (Step S404), and displays an image on the LCD 207 based on the image data written on the DRAM 205. (Step S405) Then, the user can enjoy watching the image displayed on the LCD 207, while listening to the music or sound output from the speaker 409. When the automatic performance is finished or the user ceases the automatic performance by operating the operation switch 209, a performance-cease timing or a sound-cease timing is caused. (Step S406; YES) When the performance-cease timing or the voice-cease timing is caused, the camera section 3 instructs the sound source section 4 to cease the performance or the outputting of sound. (Step S407) When the camera section 3 instructs the sound source section 4 to cease the performance or the outputting of sound, the sound source section 4 ceases the performance or the outputting of sound, (Step S205) and no sound is output from the speaker 409.

(2) Second Embodiment.

Circuitry of a digital camera 1 in the second embodiment of the invention is the same as that of the first embodiment shown in FIG. 1. In the second embodiment, tune code with a title of the tune is written into a tune-data list on the first ROM 404 shown in FIG. 2, and sound code with a title of the sound is written into a sound-data list on the first ROM 405 shown in FIG. 3.

(Image-Pickup Mode)

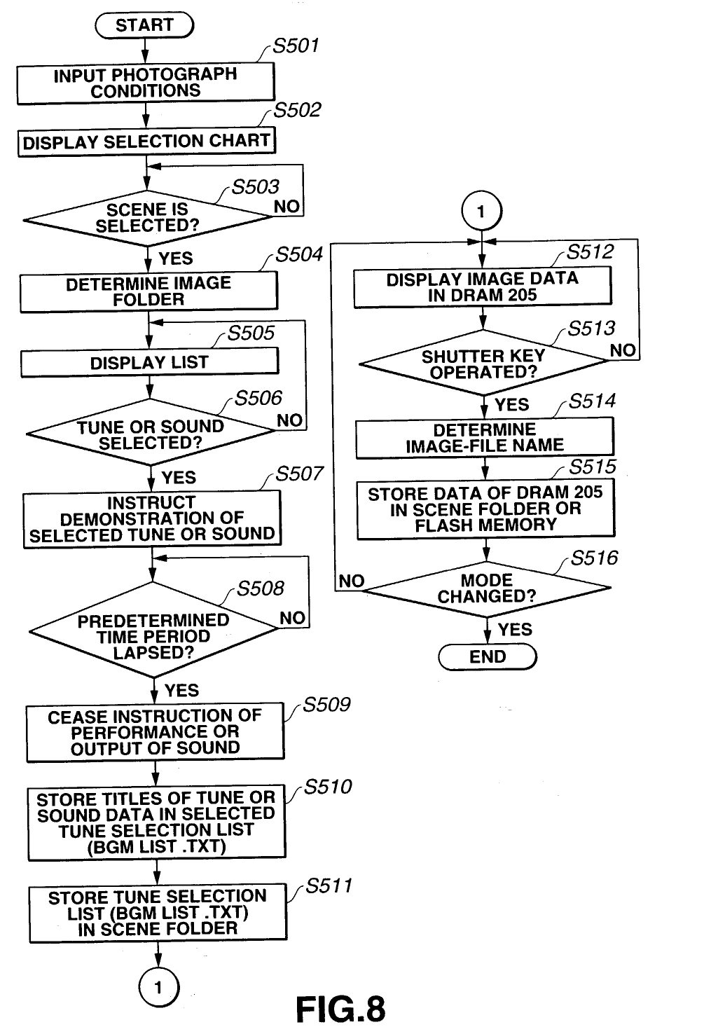

In the second embodiment, when the user selects an image-pickup mode by operating the operation switch 209, the CPU 202 in the camera section 3 starts the processing in accordance with a flowchart shown in FIG. 8 under instructions of the control program stored in the ROM 203. More specifically, the CPU 202 transfers to the camera section 3 photographing conditions such as macro photography, distant-scene photography, speed light photography or natural light photography, input through the operation switch 209, and adjusts the optical mechanism suitably for the input photographing conditions. (Step S501)

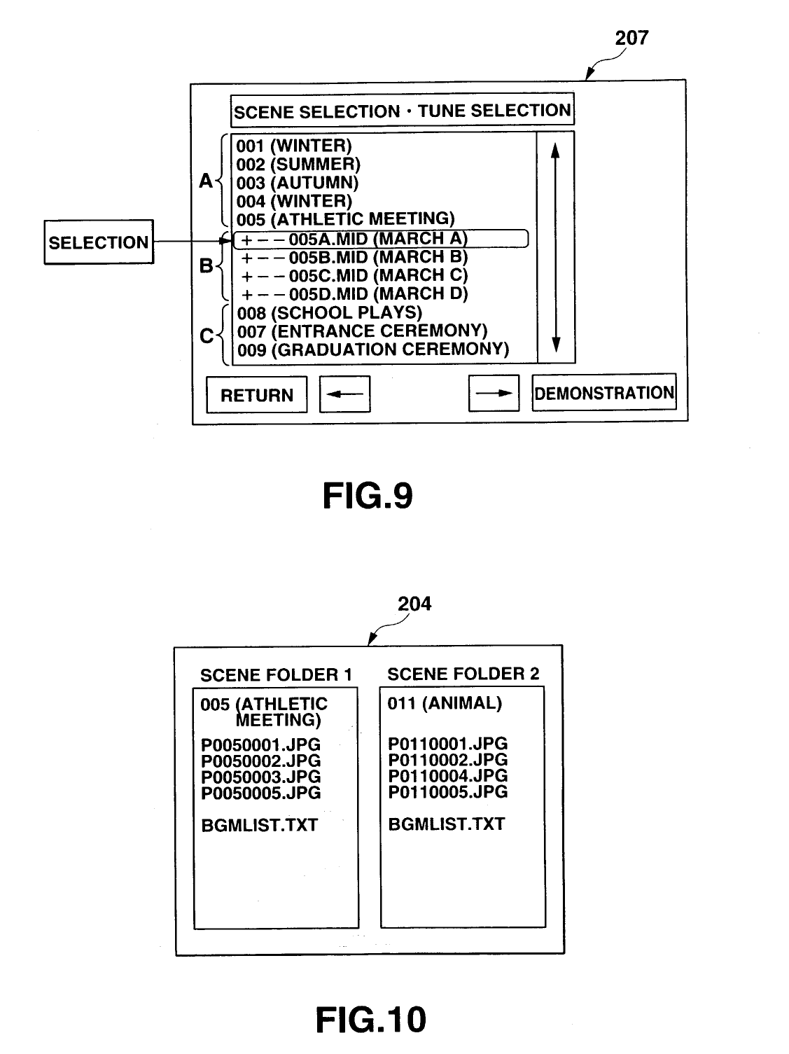

Then, the CPU 202 instructs the LCD 207 to display a selection chart for selecting a tune or sound. (Step S502) In the process at Step S502, as shown in FIG. 9 (A and B), a scene selection chart including plural scenes is displayed based on the data read out from the first and second ROM 404 and 405, which scene selection chart has a scrolling function to bring missing information into view. It is judged which scene is selected from among the plural scenes. (Step S503) When a scene is selected, an image folder is determined for holding image data in the flash memory 204. (Step S504) For example, when the first scene is selected, a “scene folder 1” is determined, and when the second scene is selected, a “scene folder 2” is determined, as shown in FIG. 10.

A list of four kinds of tunes or sounds belonging to the selected scene is displayed on the LCD 207 together with titles of the tunes and sounds. (Step S505) Therefore, if the scene “005 (Athletic meeting)” is previously selected, the list of four tunes “005A.MID (March A)”, “005B.MID (March B)”, “005C.MID (March C)” and “005D.MID (March D)” belonging to the scene “005 (Athletic meeting)” is displayed in the process at Step S505, as shown in FIG. 9C.

Now, it is judged which tune code or sound code is chosen from the selected list. (Step S506) The sound source section 4 is instructed to execute the automatic performance based on tune data corresponding to the chosen tune code or outputting of sound based on sound data corresponding to the chosen sound code. (Step S507) After a certain period of time has lapsed (Step 508; YES), the sound source section 4 is instructed to cease the demonstration of the automatic performance or outputting of sound. (Step S509) As described above, the sound source section 4 executes the automatic performance based on the tune data or outputs the sound based on the sound data for a certain period of time, as shown in FIG. 5.

Then, the camera section 3 writes the titles of tune data or sound data (tune code or sound code) into a tune selection list (BGMLIST.TXT) (Step S510), and stores the tune selection list (BGMLIST.TXT) in the scene folder. (Step S511) In other words, the tune selection list (BGMLIST.TXT) is stored in the scene folder 1 or in the scene folder 2 in the process of Step S511, as shown in 10.

Meanwhile, when the camera section 3 receives the photographing conditions in the previous process at Step S501, the optical mechanism is adjusted to meet the photographing conditions (Camera control process). (Step S301) In the Camera control process, the focus and exposure of the camera section 3 is arranged as described in the flowchart of FIG. 6 and with the adjusted photographing conditions an image data of the object is taken in through the imaging device 305. The image data is sent to DRAM 303 to be temporarily held therein (Step S302), and further transferred from the DRAM 303 to the DRAM 205 in the camera section 3.(Step S303).

Further, the camera section 3 makes the LCD 207 display an image based on the image data in the DRAM 205 as shown in the flowchart of FIG. 8. (Step S512) On the LCD 207 is displayed a through image of the object, toward which the lens of the digital camera 1 is directed. The camera section 3 keeps the LCD 207 displaying the through image of the object until the operation switch 209 is operated to click the shutter key. (Step S513) When the user clicks the shutter key at the time his desired through image of the object is displayed on the LCD 207, the process advances from Step S513 to Step S514.

After the image-file name is determined (Step S514), the mage data in the DRAM 205 is stored in the scene folder selected at Step S504 on the flash memory 204 (Step S515). Further, it is judged whether the image-pickup mode is changed to another mode. (Step S512) When it is judged that the image-pickup mode is still maintained, then the processes at Step S512 through Step S516 are repeatedly performed. In other words, every operation of the shutter key, the processes at Step S514 and Step S515 are repeatedly performed, and image data with the image filename “P0050001.JPG” through “P0050005.JPG” are stored in the “scene folder 1” and “scene folder 2” on the flash memory 204.

(Reproducing Mode)

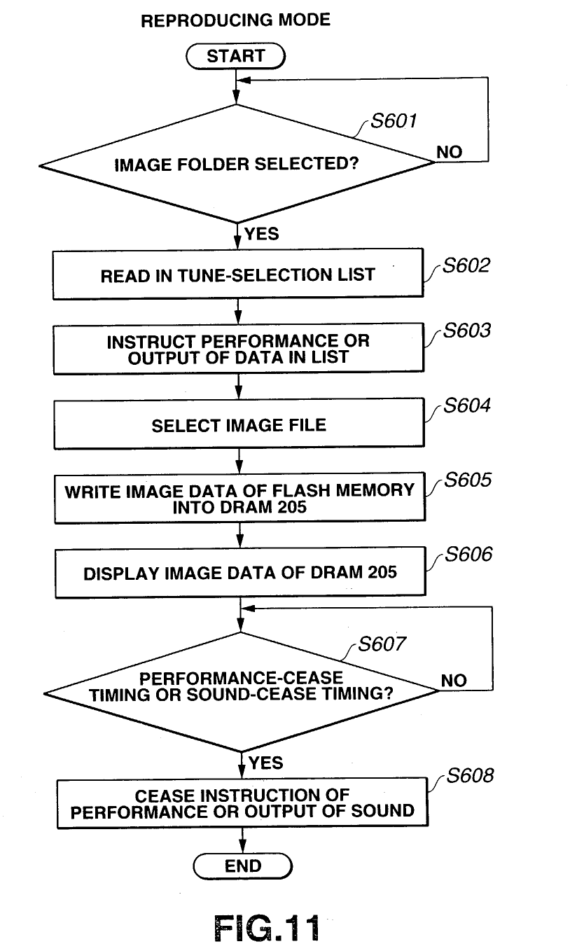

When the user selects the reproducing mode by operating the operation switch 209, the CPU 202 in the camera section 3 starts the process under the instructions of the control program stored in the ROM 203 in accordance with a flowchart of FIG. 11. The CPU 202 keeps waiting until the user selects an image folder by operating the operation switch 209. (Step S601) When an image folder is selected, a tune-selection list (BGMLIST.TXT) in the selected image folder is read in (Step S602), the CPU 202 instructs the sound source section 4 to execute a performance based on the tune data corresponding to the tune code included in the selected tune-selection list (BGMLIST.TXT) or to output voices based on sound data corresponding to the sound code included in the selected tune-selection list (BGMLIST.TXT). (Step S603) As described in the flowchart of FIG. 5, when the sound source section 4 received instruction to execute a performance or to output sounds, the tune data or sound data corresponding to the tune codes or sound code is written into the DRAM 403. (Step S 602) The sound source section 4 executes the automatic performance based on the tune data written into the DRAM 403 or outputs sounds based on the voice data written into the DRAM 403. (Step S603). In the process at Step S603, a tune or sound is output through the speaker 409.

The camera section 3 sequentially selects image files from among those in the image folder selected at Step S601 (Step S604), holds same on the DRAM 205 through the flash memory 204 (Step S605), and makes the LCD 207 display an image based on the image data held on the DRAM 205. As described, music or sound is output from the speaker 409, and images are sequentially displayed on the LCD 207. The user can enjoy watching the images sequentially displayed on the LCD 207, while listening to music or sound output from the speaker 409. When the performance is finished, or the user operates the operation switch 209 to cease the reproduction, a performance-cease timing or a sound-cease timing is caused. (Step S607; YES) When the performance-cease timing or the sound-cease timing is caused, the camera section 3 instructs the sound source section 4 to cease the performance or the outputting of sounds. (Step S608) When the camera section 3 instructs the sound source section 4 to cease the performance or the outputting of sound, the sound source 4 ceases the performance or the outputting of sound, (Step S205) and no voice is output from the speaker 409.

In the above embodiment, the LCD 207 displays the image and the speaker 409 outputs sound, and therefore the digital camera 1 itself performs the reproducing function without any help of an external attachments. However, as shown in FIG. 1, the digital camera 1 is provided with the video output terminal 208, the external interface terminal 210, and the audio output terminal 410. External attachments or apparatuses such as a monitor, a personal computer, and a speaker may be connected to these terminals 208, 210 and 410 for reproducing the image or outputting music or sound. Plural CPUs 302, 202 and 402 are used in the embodiment but the function and the performance of these CPUs may be realized with those of one or two CPUs. The DRAM 303, 205 and 403 may be replaced with one or two DRAMs.

(3) Other Embodiment.

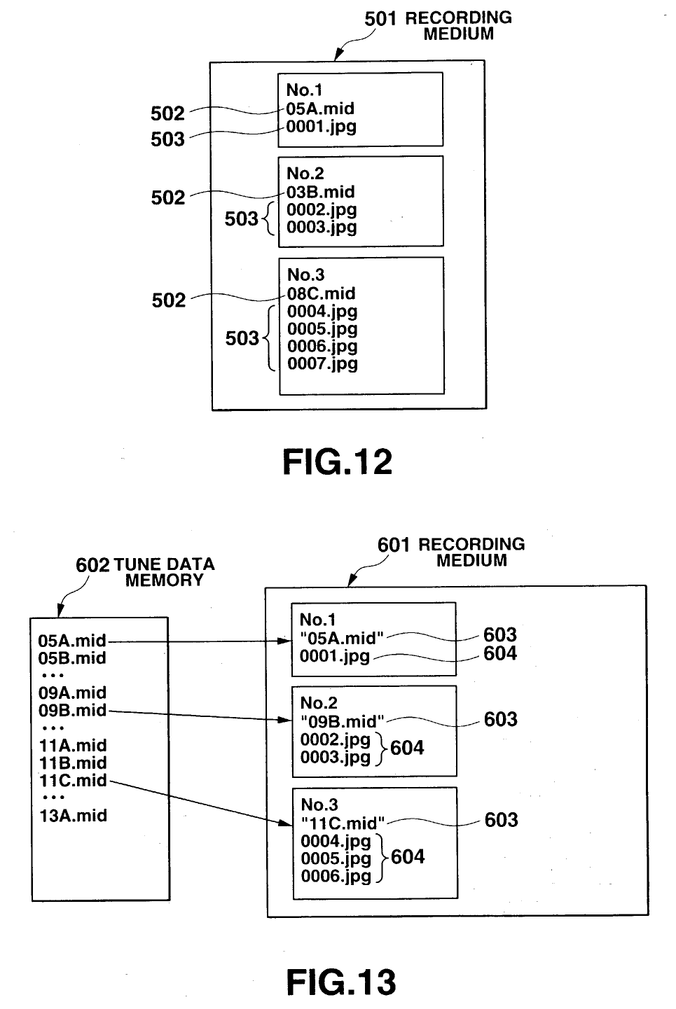

The tune data and the image data are associated with each other and recorded on the recording media as described in the first and second embodiment. But the relationship between the tune data and the image data as shown in FIG. 12 through FIG. 16 may be useful.

(a) FIG. 12

To associate MIDI file (tune data) 502 with image files (image data) 503, data including these MIDI file and image files may be stored respectively in the recording areas (Nos.1, 2, 3, . . . ) on the recording medium 501 as shown in FIG. 12. If the recording medium is an elongated tape, the above recording method is useful to keep the relationship between the MIDI file and image files.

(b) FIG. 13

To associate filenames of MIDI file (tune data) 603 with image files (image data) 604, data including these filename of MIDI file and image files may be stored respectively in the recording areas (Nos.1, 2, 3, . . . ) on the recording medium 601 as shown in FIG. 13.

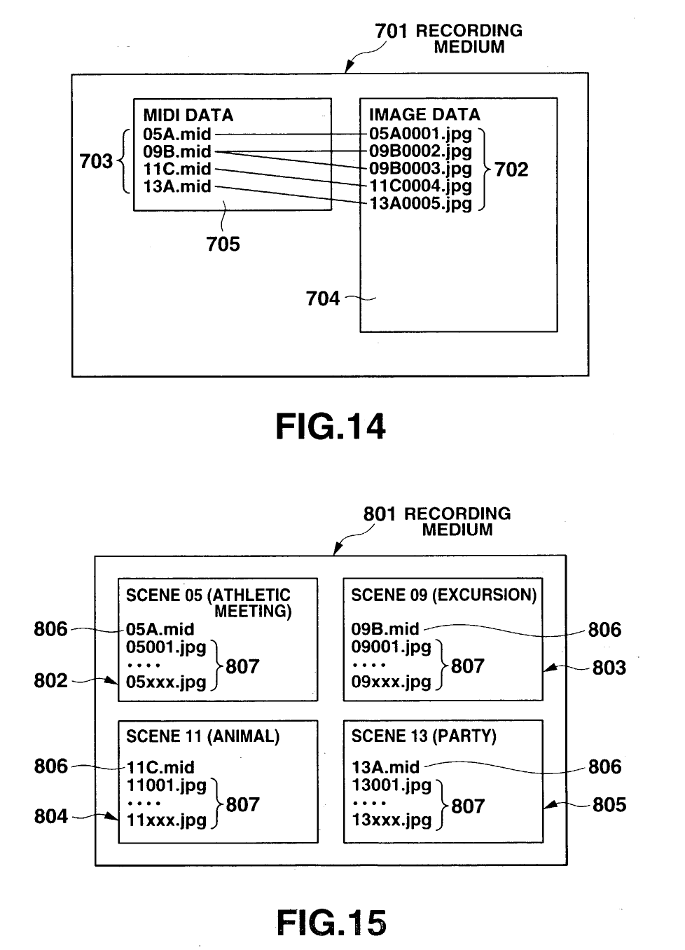

(c) FIG. 14

Filenames of image files 702 and filenames of MIDI data files 703 are associated with each other and are stored respectively in folders 704, and 705 on a recording medium 701, as shown in FIG. 14.

(d) FIG. 15.

On a recording medium 801 are prepared image folders 802, 803, 804 and 805 for selected scenes, and data including MIDI data file 806 and image data files 807 are held in each of the image folders 802, 803, 804 and 805. This method is similar to those described in the second embodiment.

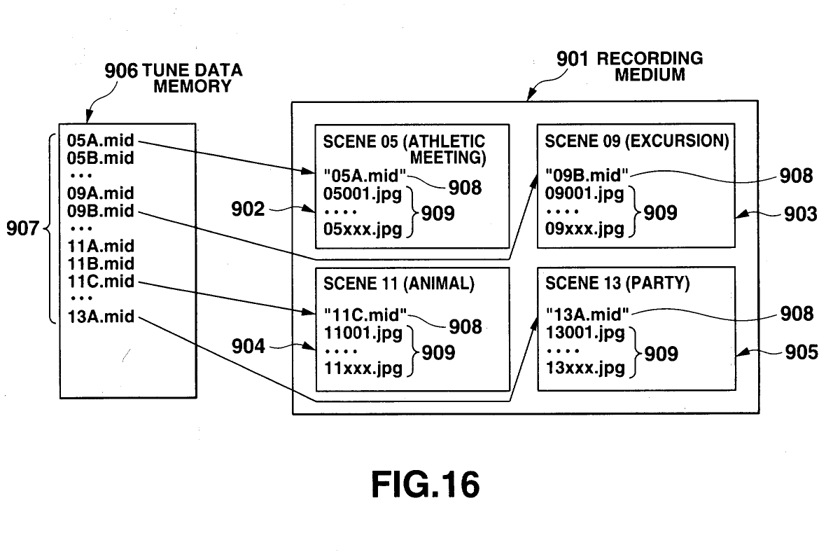

(e) FIG. 16.

On a recording medium 901 are prepared image folders 902, 903, 904 and 905 for selected scenes, and a filename 908 of MIDI data 907 held in a tune-data memory 906 and filenames 909 of image data are stored in each of the image folders. This method is similar to those described in the second embodiment.

As described above, in the method of storing data according to the invention, the image-data identifying data for identifying the image data and the sound-data identifying data for identifying the sound data to be added to the image data, or the image data and the sound-data identifying data for identifying the sound data to be added to the image data, or the image-data identifying data for identifying the image data and the sound data to be added to the image data are associated with each other and stored on the storage. Therefore, without any processing to edit both of the image data and the sound data or other post processing, the image data and the desired sound data may be associated with each other and stored in a simple manner.

Further, in the method of storing and reproducing data according to the invention, without any processing to edit the image data, the sound data, or both of the image data and sound data or other post processing, the image data and the desired sound data may be associated with each other and stored in a simple manner, and an image is displayed based on the image data and desired sound is output based on the sound data simultaneously.

According to the image-pickup apparatus of the invention, without any processing to edit the image data and the sound data, or other post processing, the image data and the desired sound data may be associated with each other and stored in a simple manner, and an image is displayed based on the image data and desired sound is output based on the sound data simultaneously. Therefore, the image of the object together with the desired sound may be stored and reproduced without using a complex data-editing process.

What is claimed is:

1. A method of storing data comprising:
setting picture-taking conditions;
displaying a scene selection screen;
selecting one scene from the displayed scenes;
selecting a folder into which an image corresponding to the selected scene is to be stored;
displaying a sound data list belonging to the selected scene;
selecting one sound from the displayed sound data list;
making a demonstration playing of the selected sound data;
storing identifying data for identifying the selected sound data into the scene folder;
taking a picture of an image; and
storing image data obtained by the picture-taking into the scene folder in association with the identifying data of the sound data.

2. A method of playing back recorded data comprising:
selecting a playback mode;
displaying a scene folder;
selecting one sound data belonging to the displayed scene folder;
making a demonstration playing of the selected sound data;
reading out stored image data by identifying data stored in association with the selected sound data.

3. A method for storing data comprising:
selecting in response to a first operation by a user, a tune code from a plurality of tune codes stored in a first storage;
obtaining image data in response to a second operation by the user;
creating a filename for storing obtained image data, by using the selected tune code in response to the second operation of the user; and
storing in a second storage the obtained image data with the created filename.

4. An apparatus comprising:
a non-volatile memory for storing image files and tune data; and
a sound source section, wherein the image file stored in the non-volatile memory has an image filename including a series of characters corresponding to the tune data stored in the non-volatile memory, and when the image file is browsed, the sound source section reproduces a tune signal based on the tune data corresponding to the image filename of the browsed image file.

5. An apparatus comprising:
a non-volatile memory; and
a sound source section, wherein the non-volatile memory is provided with scene folders corresponding to previously selected scenes and a tune selection list in which titles of previously selected tune data are described and when the image file is browsed, the sound source section reproduces a tune signal based on the tune data in the tune selection list provided in the non-volatile memory.

6. A method for storing and reproducing data comprising:
selecting in response to a first operation by a user a tune code from a plurality of tune codes stored in a first storage;
obtaining image data in response to a second operation by the user;
preparing in response to the second operation of the user an image-file name for storing the obtained image data, by using the selected tune code;
storing in a second storage the obtained image data with the prepared image-file name;
selecting in response to a third operation by the user an image-file name from a plurality of image-file names stored in the second storage;
reading out the image data contained in the selected image-file name stored in the second storage, and reproducing an image based on the read out image data;
detecting the tune code used in the image-file name selected in response to the third operation by the user; and
reading out from the first storage, MIDI data represented by the detected tune code and reproducing a tune based on the read out MIDI data.

7. An image-pickup apparatus responsive to operation by a user comprising:
first storing means for storing MIDI data of plural tunes and tune codes representing the MIDI data respectively;
first selecting means for selecting in response to the first selecting operation by the user a tune code from among the tune codes stored in the first storing means;
a shutter key;
image-pickup means for taking a picture of an object in response to an operation by the user of the shutter key to obtain image data of an object;
filename preparing means for creating in response to the operation by the user of the shutter key an image-file name for storing the image data of the object obtained by the image-pickup means by using the tune code selected by the first selecting means;
second storing means for storing the image data with the image-file name prepared by the filename preparing means;
second selecting means for selecting in response to the second selecting operation by the user an image-file name from among the image-file names stored in the second storing means;
image-reproducing means for reading out from the second storing means the image data represented by the image-file name selected by the second selecting means, and for reproducing an image based on the read out image data;
detecting means for detecting a tune code used in the image filename selected by the second selecting means; and
tune-reproducing means for reading out from the first storing means the MIDI data of the tune represented by the tune code detected by the detecting means, and reproducing the tune based on the read out MIDI data.

8. An image-pickup apparatus comprising:
a camera section;
a sound source section; and
a control section;
wherein the camera section comprises:
an imaging device for obtaining image data of an object;
the sound source section comprises:
a first storage for storing at least one musical-sound data;
a converter for generating a digital musical signal from the musical-sound data stored in the first storage and for converting the generated digital musical signal into an analog signal; whereby the converter outputs an audio signal corresponding to the musical-sound data; and
the control section comprises:
a second storage for storing the image data obtained by the camera section;
a non-volatile memory cooperative with the second storage for reading and writing the image data obtained by the camera section and for storing the image data in a file format;
a display device for displaying an image based on the image data stored in the second storage; and
an operation switch,
and wherein the image data stored in the file format on the non-volatile memory has an image-file name which includes a tune code corresponding to the musical-sound data which is selected from musical-sound data previously stored in the first storage by the operation by the user of the operation switch, and when the image file is browsed, the sound source section outputs a musical sound signal based on the musical-sound data corresponding to the image-file name of the browsed image file.

9. An image-pickup apparatus according to claim 8, wherein the first storage of the sound section stores at least an electronic music data, and the sound-source section has a performance circuit for converting the electronic music data stored in the first storage into a digital voice signal.

10. A method of storing image data comprising:
selecting in response to a selecting operation of a user, a piece of sound information from plural pieces of sound information which are stored in a first storage together with sound-information identifying information;
obtaining image data in response to an obtaining operation by the user;
creating a filename for storing the obtained image data, by using the sound-information identifying information for identifying the selected sound information; and
storing in a second storage the obtained image data with the created filename.

11. A method of storing image data comprising:
selecting in response to a selecting operation of a user, a piece of sound information from plural pieces of sound information which are stored in a first storage together with sound-information identifying information;
obtaining image data in response to an obtaining operation by the user;
selecting a folder from plural folders; and
storing in the selected folder sound-information identifying information for identifying the selected sound information and the obtained image data.

12. The method of storing image data according to claim 11, wherein the sound information comprises tune data, and the sound-information identifying information comprises a tune code representing tune data.

13. The method of storing image data according to claim 11, wherein the tune data comprises MIDI data of the tune.

14. The method of storing image data according to one of claims 11, wherein the obtained image data comprises image data which is obtained by taking a picture of an object.

15. A method of storing image data comprising:
displaying plural scenes for selection;
selecting a scene from the plural displayed scenes;
selecting a scene folder corresponding to the selected scene;
displaying a list of sound information belonging to the selected scene;
selecting a piece of sound information from the displayed list of sound information;
storing in the selected scene folder sound-information identifying information for identifying the selected sound information;
obtaining image data by taking a picture of an object; and
storing the obtained image data in the scene folder where the sound-information identifying information has been stored.

16. A method of reproducing recorded data comprising:
selecting a reproducing mode;
displaying in response to the reproducing mode selection a scene folder where image data for each scene and sound-information identifying information for identifying sound information are previously stored;
selecting the sound-information identifying information stored in the scene folder;
reading out from a storage the sound information identified by the selected sound-information identifying information to perform a sounding process; and
displaying an image based on the image data which is stored in the scene folder together with the sound-information identifying information.

17. A method of storing and reproducing image data comprising:
selecting in response to a selecting operation of a user, a piece of sound information from plural pieces of sound information which are stored in a first storage together with sound-information identifying information;
obtaining image data in response to an obtaining operation by the user;
creating a filename for storing the obtained image data, using the sound-information identifying information for identifying the selected sound information; and
storing in a second storage the obtained image data with the created filename;
selecting in response to a selecting operation by the user in a reproducing mode an image filename from the image filenames stored in the second storage;
reading out from the second storage image data represented by the selected image filename and reproducing an image based on the read out image data;
detecting the sound-information identifying information used in the selected image filename;
reading out from the first storage sound information identified by the detected sound-information identifying information; and
reproducing sound based on the read out sound information.

18. A method of storing and reproducing image data comprising:
selecting in response to a selecting operation of a user, a piece of sound information from plural pieces of sound information which are stored in a storage together with sound-information identifying information;
obtaining image data in response to an obtaining operation by the user;
selecting a folder from plural folders;
storing in the selected folder sound information identifying information identifying the selected sound information and the obtained image data;
selecting a folder from the plural folders in response to selecting operation by a user in a reproducing mode;
reading out image data stored in the folder selected in the reproducing mode and reproducing an image based on the read out image data;
detecting the sound-information identifying information stored in the folder selected in the reproducing mode;
reading out the storage sound information identified by the detected sound-information identifying information from; and
reproducing sound based on the read out sound information.

19. The method of storing and reproducing image data according to claim 18, wherein the sound information comprises tune data, and the sound-information identifying information comprises a tune code representing tune data.

20. The method of storing and reproducing image data according to claim 18, wherein the tune data comprises MIDI data of the tune.

21. The method of storing and reproducing image data according to one of claims 18, wherein the obtained image data comprises image data which is obtained by taking a picture of an object.

22. An image-pickup apparatus comprising:
a sound source section and a camera section;
wherein the sound source section comprises:
sound-information storing means for storing plural pieces of sound information and plural pieces of sound-information identifying information for identifying the plural pieces of sound information respectively; and
the camera section comprises:
image pickup means for taking a picture of an object to obtain in image data of the object;
image-filename creating means for creating an image filename using previously selected sound source information;
storing means for storing the image data of the object obtained by the image pickup means in the image filename created by the image-filename creating means; and
image reproducing means for reading out from the storing means in a reproducing mode the image data represented by a previously selected image filename to reproduce an image based on the read out image data, and
wherein the sound source section further comprises sound reproducing means for reproducing sound based on the sound information identified by the sound-information identifying information used in the previously selected image filename.

23. An image-pickup apparatus comprising:
a sound source section and a camera section;
wherein the sound source section comprises:
sound-information storing means for storing plural pieces of sound information and plural pieces of sound-information identifying information for identifying the plural pieces of sound information respectively; and
the camera section comprises:
image pickup means for taking a picture of an object to obtain in image data of the object;
storing means for associating the image data of the object obtained by the image pickup means with a previously selected sound-information identifying information, and for storing the image data and the sound-information identifying information associated with each other; and
image reproducing means for reading out from the storing means in a reproducing mode previously selected image data, and for reproducing an image based on the read out image data, and
wherein the sound source section further comprises sound reproducing means for reproducing sound based on the sound information identified by the sound-information identifying information associated with the previously selected image data.

24. The image-pickup apparatus according to claim 23, wherein the storing means stores the image data obtained by the image pickup means in a scene folder previously selected form plural scene folders which correspond to scenes respectively with by associate, whereby associating the image data with the scene folder.

25. The image-pickup apparatus according to claim 24, wherein the sound information comprises tune data, and the sound-information identifying information comprises a tune code representing tune data.

26. The image-pickup apparatus according to claim 24, wherein the tune data comprises MIDI data of the tune.

27. An image pickup apparatus comprising:
a camera section having an image pickup element for obtaining image data;
a first storage for storing at least one music data;
a sound source section having a converter for converting a digital music signal to an analog signal, the digital music signal being composed of the music data, wherein the sound source outputs an audio signal based on a selected music data;
a second storage for storing the image data obtained by the camera section;
a non-volatile memory cooperative with the second storage for reading and writing the image data obtained by the camera section, and for storing the image data in a file format;
a display device for displaying an image based on the image data stored in the second storage; and
a control section having an operation switch,
wherein a filename stored in the non-volatile memory contains as a part of the name the tune code corresponding to the music data previously selected from music data stored in the first storage by the operation switch, and the sound source section outputs an audio signal based on the music data of the tune code corresponding to the image filename, when the image files are refered.

28. An image pickup apparatus comprising:
first storing means for storing MIDI data for plural tunes and tune codes each representing MIDI data for a tune;
first selecting means for selecting in response to a selecting operation by a user a tune code from the plural tune codes stored in the first storing means;
image pickup means for taking a picture of an object in response to a shutter-key operation by a user to obtain image data of the object;
filename creating means for creating an image filename using the tune code which is selected in response to the selecting operation by the first selecting means;
second storing means for storing the image data with the image filename created by the filename creating means;
second selecting means for selecting in response to a selecting operation in a reproducing mode, an image filename from the image filenames stored in the second storing means;
image reproducing means for reading out from the second storing means the image data represented by the image filename selected by the second selecting means, and for reproducing an image based on the read out image data;
detecting means for detecting a tune code used in the image filename selected by the second selecting means; and
tune reproducing means for reading out from the first storing means MIDI data represented by the tune code detected by the detecting means, and for reproducing a tune based on the read out MIDI data.

29. The image pickup apparatus according to claim 28, wherein the sound source section has at least an electronic music data stored in the first storage, and comprises a performance circuit for converting the electronic music data to a digital audio signal.
